(19) United States
(12) Patent Application Publication
(10) Pub. No.: US 2020/0318770 A1
(43) Pub. Date: Oct. 8, 2020

(54) SYSTEMS AND METHODS FOR DISSIPATING FLUID VELOCITY

(71) Applicant: Ty L. Soukup, Broomfield, CO (US)

(72) Inventor: Ty L. Soukup, Broomfield, CO (US)

(21) Appl. No.: 16/838,859

(22) Filed: Apr. 2, 2020

Related U.S. Application Data
(60) Provisional application No. 62/830,166, filed on Apr. 5, 2019.

(51) Int. Cl. F16L 55/027; F16L 55/07

(52) U.S. Cl. CPC F16L 55/02736; F17D 1/20; F16L 55/07

(57) ABSTRACT

Methods, systems, and devices for dissipating fluid velocity are described. An example apparatus for dissipating fluid velocity may include an elongated pipe configured to allow fluid to flow therethrough, the elongated pipe having a first end and a second end. The apparatus may include an inlet portion at the first end of the elongated pipe, an outlet portion at the second end of the elongated pipe, and a dissipation chamber between the inlet portion and the outlet portion. The dissipation chamber may be configured to reduce a velocity of a stream of the fluid along a direction from the inlet portion to the outlet portion, where a cross-sectional area of the dissipation chamber perpendicular to the direction from the inlet portion to the outlet portion is greater than a cross-sectional area of the inlet portion perpendicular to the direction from the inlet portion to the outlet portion.

### CROSS REFERENCE

The present Application for Patent claims the benefit of U.S. Provisional Patent Application No. 62/830,166 by Soukup, entitled “SYSTEMS AND METHODS FOR DISSIPATING FLUID VELOCITY,” filed Apr. 5, 2019, which is expressly incorporated by reference herein.

### FIELD OF TECHNOLOGY

Aspects of the present disclosure relate generally to dissipating a velocity of a stream of fluid, and more particularly to a velocity dissipation chamber deployed in a piping system, such as piping systems for high pressure pumping applications.

### BACKGROUND

In high pressure pumping applications, automated control valves may be installed to keep a high-pressure pump within its operating envelope. This may be referred to as keeping the pump on its pump curve. Control valves may reduce the cross-sectional flow area for the fluid being pumped. When the cross-sectional flow area is reduced, the velocity of the fluid increases. As fluid velocity increases, the erosional nature of the fluid stream increases. Additionally, as a control valve opens and closes, the direction of fluid may change as the fluid passes through the control mechanism, which may result in a high velocity stream (e.g., jet stream) of the fluid. In some cases, the high velocity stream may impact the sidewall of downstream piping or valves. Further, control valves may be designed in piping systems to directly abut downstream valves. When high velocity streams impact downstream valves and piping in conventional systems, damage to the downstream valves or piping may occur, which may result in large, uncontrollable, and dangerous leaks of the fluid being pumped in the system.

### SUMMARY

Implementations described and claimed herein address the foregoing problems by providing apparatuses, systems, and methods for dissipating a velocity of a stream of fluid. Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

An apparatus for a fluid pumping system is described. The apparatus may include an elongated pipe configured to allow fluid to flow therethrough, the elongated pipe having a first end and a second end, an inlet portion at the first end of the elongated pipe, an outlet portion at the second end of the elongated pipe, and a dissipation chamber between the inlet portion and the outlet portion, the dissipation chamber configured to reduce a velocity of a stream of the fluid along a direction from the inlet portion to the outlet portion, where a cross-sectional area of the dissipation chamber perpendicular to the direction from the inlet portion to the outlet portion is greater than a cross-sectional area of the inlet portion perpendicular to the direction from the inlet portion to the outlet portion.

In some examples of the apparatus described herein, a length of the dissipation chamber along a longitudinal axis of the elongated pipe is greater than a length of the inlet portion and the outlet portion along the longitudinal axis of the elongated pipe. In some examples of the apparatus described herein, a diameter of the dissipation chamber is greater than a diameter of the inlet portion and the outlet portion.

Some examples of the apparatus described herein may further include one or more baffles, one or more vanes, or one or more plates, or a combination thereof coupled to an inner sidewall of the dissipation chamber, the one or more baffles, the one or more vanes, or the one or more plates, or the combination thereof configured to reduce the velocity of the fluid along the direction from the inlet portion to the outlet portion.

Some examples of the apparatus described herein may further include one or more wear plates coupled to the dissipation chamber and positioned with respect to a contact position of one or more streams of the fluid on an inner sidewall of the dissipation chamber. In some examples of the apparatus described herein, the one or more wear plates cover a circumference of the inner sidewall of the dissipation chamber. Some examples of the apparatus described herein may further include one or more wear plates coupled to the inlet portion and positioned with respect to a contact position of one or more streams of the fluid on an inner sidewall of the inlet portion.

Some examples of the apparatus described herein may further include a sloping section between the dissipation chamber and the inlet portion, where the sloping section is based on a first diameter of an inner wall of the inlet portion and a second diameter of an inner wall of the dissipation chamber. In some examples of the apparatus described herein, a position and a slope of the sloping section is based on an angle of the stream of fluid.

Some examples of the apparatus described herein may further include a drain port coupled with the velocity dissipation chamber configured to drain excess fluid from the velocity dissipation chamber. In some examples of the apparatus described herein, the dissipation chamber is welded to the inlet portion and the outlet portion.

A fluid pumping system is described. The system may include a control valve configured to control a stream of fluid from upstream piping to an outlet of the control valve, a velocity dissipation chamber coupled with the control valve at an inlet end of the velocity dissipation chamber and configured to reduce a velocity of the stream of fluid along a direction between the outlet of the control valve and an outlet end of the velocity dissipation chamber, and a downstream equipment coupled to the outlet end of the velocity dissipation chamber.

Some examples of the system described herein may further include a high pressure pump configured to pump the fluid through the upstream piping to the control valve according to an operating envelope of the high pressure pump.

Some examples of the system described herein may further include at least one baffle, vane, or plate within the velocity dissipation chamber configured to reduce the velocity of the stream of fluid along the direction between the outlet of the control valve and the outlet end of the velocity dissipation chamber.

Some examples of the system described herein may further include one or more wear plates within the velocity dissipation chamber and positioned with respect to a point of contact of the stream on an inner wall of the velocity dissipation chamber.

In some examples of the system described herein, the velocity dissipation chamber is configured to reduce the velocity of stream of fluid according to one or more specifications of the downstream equipment.

In some examples of the system described herein, a diameter of the velocity dissipation chamber is greater than a diameter of the downstream equipment.

A method for dissipating fluid velocity is described. The method may include pumping, using a high pressure pump, fluid through upstream piping to an upstream control valve, increasing a velocity of one or more jets of the fluid at an outlet of the upstream control valve using the upstream control valve, reducing, using a velocity dissipation chamber, the velocity of the one or more jets of the fluid exiting the upstream control valve, and flowing the one or more jets of the fluid through an outlet of the velocity dissipation chamber at the reduced velocity.

Some examples of the method described herein may further include operations for reducing the velocity of the one or more jets using one or more baffles, one or more vanes, or one or more plates, or a combination thereof within the velocity dissipation chamber.

Some examples of the method described herein may further include operations for flowing the one or more jets of the fluid through the outlet to a downstream valve, where the velocity of the one or more jets is reduced based on one or more specifications of the downstream valve.

### BRIEF DESCRIPTION OF THE DRAWINGS

FIG. 1 illustrates an example of a saltwater disposal system that supports dissipating fluid velocity in accordance with aspects of the present disclosure.

FIGS. 2A and 2B illustrate examples of a perspective view of a fluid velocity dissipation chamber in accordance with aspects of the present disclosure.

FIG. 2C illustrates an example of a three dimension cross-sectional view of a fluid velocity dissipation chamber in accordance with aspects of the present disclosure.

FIG. 3 illustrates an example of a two dimension cross-sectional view of a fluid velocity dissipation chamber in accordance with aspects of the present disclosure.

FIG. 4 illustrates an example of a high pressure piping system that supports dissipating fluid velocity in accordance with aspects of the present disclosure.

FIG. 5 shows a flowchart illustrating a method of dissipating fluid velocity in accordance with aspects of the present disclosure.

FIGS. 6 and 7 illustrate simulation results of a VDC modeled in accordance with aspects of the present disclosure.

### DETAILED DESCRIPTION

Aspects of the presently disclosed technology relate to systems and methods for dissipating a velocity of a stream of fluid. In one aspect, a Velocity Dissipation Chamber (VDC) is provided, which may be installed in piping systems between control valves and downstream fittings, valves, and piping. The diameter, length, and material of the VDC may be customized based on the application specifications, operating parameters of the components of the system, application goals, or other factors. The VDC may be designed from materials suitable for the fluid type moving through the piping system and suitable to handle the highly erosive nature of high-velocity directed jets of such fluid. Using a combination of varying diameter, length, and materials, an application specific VDC may be designed and installed in a piping system between upstream control valve, which may provide back pressure for a pump, and downstream valves and piping. The VDC may handle the highly erosional nature of the high velocity jets with minimal to no damage while dissipating the energy through a larger diameter and longer section of pipe. At the exit or outlet of the VDC, fluid velocities may be reduced to velocities within the acceptable specifications of the downstream piping and valves, which may reduce the likelihood of erosional damage to the expensive downstream valves, fittings, and piping.

Examples of use may include, but are not limited to, the oil and gas industry. In some examples, the VDC may be used in pumping systems where control valves are used to maintain pressure and flowrates to protect high cost pumps. Specifically, a VDC may be installed between the control valve and downstream check valves and isolation valves on a salt-water disposal system using a horizontal multi-stage centrifugal pump.

The presently disclosed technology may provide velocity or energy dissipation of a fluid by including additional dissipation baffles within the internal body of the VDC, which may reduce the length of the VDC used to provide adequate dissipation (such that damage to downstream components or the VDC itself is reduced, minimized, or eliminated). Such baffles may facilitate retro-fit installations into existing piping systems. Alternatively, or additionally, the presently disclosed technology may include layering of higher strength, higher erosional resistant alloys inside the VDC to further protect the VDC from erosional damage caused by the jet streams.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The specification, examples, and data herein provide a complete description of the structure and use of example implementations of the disclosure. Various modifications and additions may be made to the implementations discussed without departing from the spirit and scope of the presently disclosed technology. For example, while some implementations refer to particular features, the scope of this disclosure also includes implementations having different combinations of features and implementations that do not include all of the described features. Accordingly, the scope of the presently disclosed technology is intended to embrace all such alternatives, modifications, and variations together with all equivalents thereof.

Aspects of the disclosure are initially described in the context of a saltwater disposal system. Aspects are then described with respect to VDCs and systems employing such components. Aspects of the disclosure are further illustrated by and described with reference to apparatus diagrams, system diagrams, and flowcharts that relate to dissipating fluid velocity in piping.

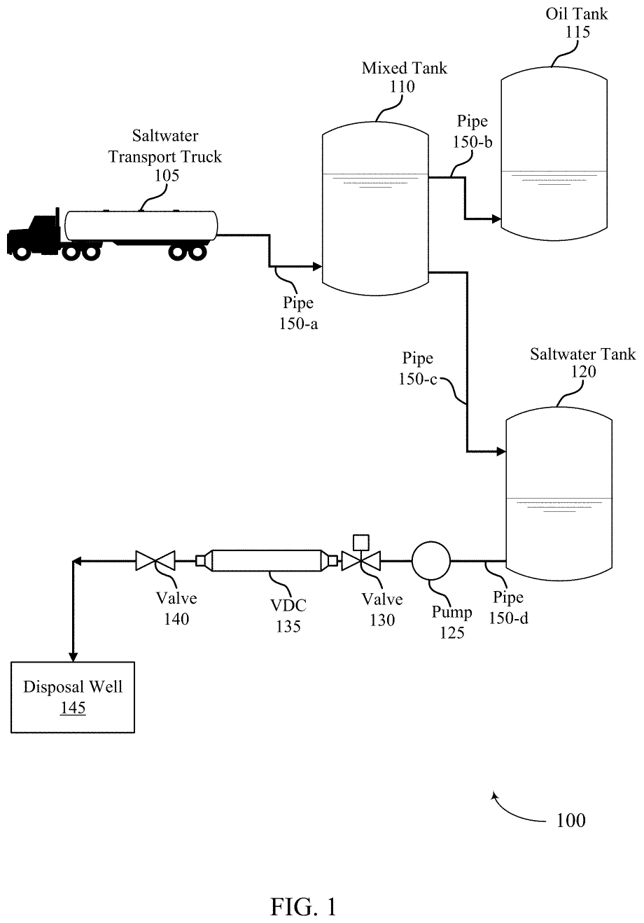

FIG. 1 illustrates an example of a saltwater disposal system 100 that supports fluid velocity dissipation in accordance with aspects of the present disclosure. The saltwater disposal system 100 may include a saltwater transport truck 105, a mixed tank 115, an oil tank 115, a saltwater tank 120, and a disposal well 145, among others. In some examples, the saltwater disposal system 100 may be implemented as, or may be part of, a high pressure system.

The saltwater transport truck 105 may carry a mixture of oil and saltwater collected from fluid produced in a well. The mixture may be emptied from the saltwater transport truck 105 through pipe 150-a to the mixed tank 110. The mixture may be given time to naturally separate in the mixed tank 110 such that oil forms a top layer in the mixed tank 110 and saltwater gravitates to the bottom of the mixed tank 110. The oil layer may be transported through pipe 150-b to oil tank 115, and the oil may be transferred to another truck or vehicle (not shown). The saltwater layer may be transported (e.g., pumped) through pipe 150-c to the saltwater tank 120. The saltwater in the saltwater tank 120 may then be pumped to a disposal well 145 through pipe 150-d, which may of a given diameter (3 inch, 4 inch, 6 inch, etc.). In some examples, the saltwater pumped to the disposal well 145 may be pumped at high pressures (e.g., greater than 100 pounds per square inch (psi)).

Pump 125 may be a centrifugal pump. For example, pump 125 may be a horizontal multi-stage centrifugal pump. Centrifugal pumps may be used to transport fluids (e.g., saltwater) by the conversion of rotational kinetic energy of impellers in each stage to the hydrodynamic energy of the fluid flow. The rotational energy typically comes from an engine or electric motor. In some cases, horizontal multi-stage centrifugal pumps may be expensive and may be protected by a valve 130 to maintain pressure and flowrates such that the pump 125 operates along its pump curve. The pipe 150-d and equipment (e.g., valves 130 and 140) downstream of the pump 125 may be designed to withstand flowrates based on the upper design limits (e.g., maximum output) of the pump 125.

Valve 130 may be a control or choke valve. In some cases, the valve 130 may be controlled by an actuated controller. The valve 130 may provide back pressure control at the outlet of the pump 125 such that the valve 130 input is the pump 125 output. In some examples, the valve 130 may be a choke valve with two orifice openings (e.g., two quarter inch orifices). When the orifices are partially open, a small surface area may form for the fluid to flow through, which may result in one, or in some cases multiple, high velocity fluid stream that may be directed to the sidewall of pipe 150-d or valve 140. When the orifices are completely open, the reduction in surface area of the orifices relative to the pipe may also result in at least one high velocity fluid stream.

The high velocity fluid streams, which may also be referred to as jet streams, may erode and damage downstream pipe 150-d and valve 140. This damage may be due to the downstream equipment being designed for the fluid velocity of the pump outlet and not the jet stream out of the valve 130. In some cases, previous models may assume that the jet stream returns to the flow rate of the pump outlet within an acceptable distance (e.g., immediately). Thus, previous systems may not be designed to handle the erosion of the jet stream. The erosion may lead to frequent leaks and costly replacements (e.g., of valve 140). Specifically, saltwater may be a corrosive fluid in addition to the damage caused by erosion at high velocities.

As described herein, a VDC 135 may be installed directly downstream of valve 130 to allow the jet streams from valve 130 to dissipate to an acceptable flowrate to reduce damage of downstream equipment (e.g., valve 140, or other valves components downstream of the VDC 135). For example, a jet stream may exit valve 130 and enter the VDC 135, which may have a different diameter and sidewall thickness than pipe 150-d. The VDC 135 may be designed to handle high pressure and high velocity fluid, which may allow the fluid of the jet stream to return to a velocity within the design parameters for the downstream equipment. In some examples, the velocity of the fluid is lessened in the VDC 135 such that the fluid may not damage the downstream pipe 150-d and fittings (e.g., valve 140). For example in a 4 inch pipe system, the pump 125 may produce an output fluid velocity of about 10 feet per second (fps), and the reduced diameter of valve 130 may increase the fluid velocity at the output of the valve 130 to greater than 10 fps (e.g., greater than 15 fps or between 50 fps to 140 fps) based on the size of the valve 130 outlet(s). The VDC 135 may intake the fluid at a velocity greater than 10 fps (e.g., greater than 15 fps or between 50 fps to 140 fps) and may produce an output fluid velocity of less than 15 fps or less than 10 fps.

Although the VDC 135 is described with reference to saltwater disposal system 100, a VDC 135 is not limited to saltwater disposal applications. For example, a VDC 135 may be included in any fluid pumping system. In some examples, a fluid pumping system may be a high pressure system. High pressure may be relative to the industry, application, etc. of the system. For instance, 100 psi may be considered high pressure in residential household applications. In the oil and gas industry, 100 psi may be considered low pressure, while greater than 300 psi may be considered high pressure. Different applications may result in different VDC design and material (e.g., carbon steel or stainless steel).

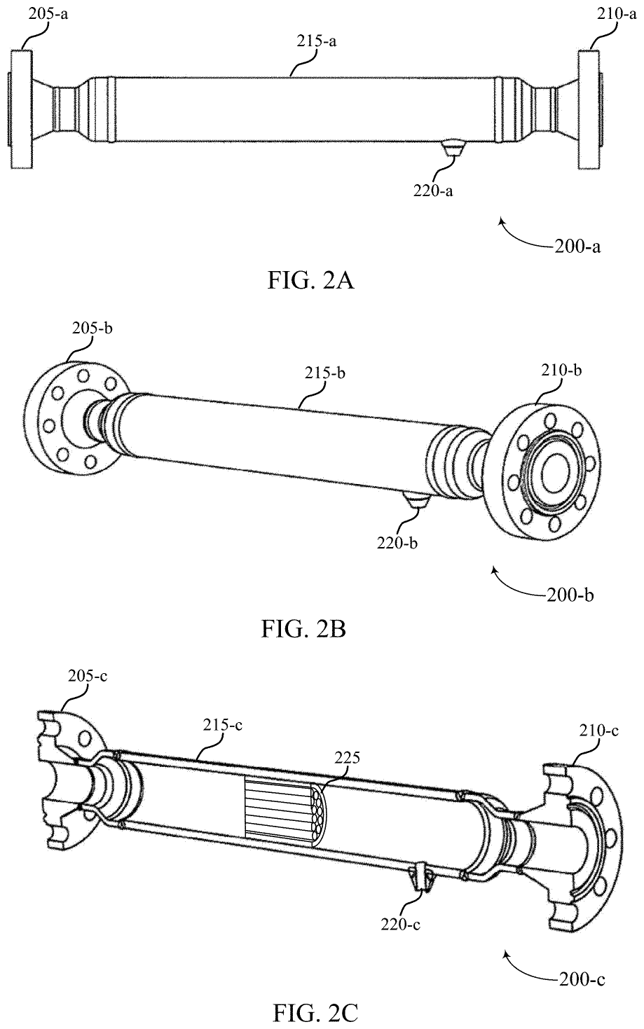

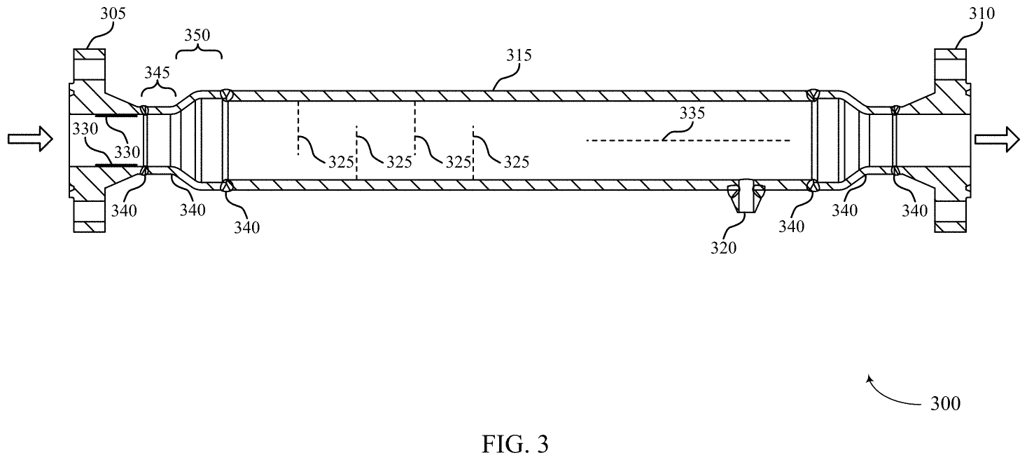

FIGS. 2A, 2B, and 2C illustrate examples of a perspective view of a fluid VDC 200 in accordance with aspects of the present disclosure. In some examples, fluid VDC 200 may be an example of VDC 135 in saltwater disposal system 100, as described with reference to FIG. 1. The fluid VDC 200 may include an inlet 205, an outlet 210, and a wide diameter chamber 215. Optionally, the fluid VDC 200 may also include a drain port 220.

FIG. 2A shows a side perspective view of a fluid VDC 200-a in accordance with aspects of the present disclosure. The fluid VDC 200-a may include an inlet 205-a, an outlet 210-a, and a wide diameter chamber 215-a. The wide diameter chamber 215-a may have a length of at least three times the inner diameter of upstream pipe or an inner diameter of the inlet 205-a. Optionally, the fluid VDC 200-a may also include a drain port 220-a. The inlet 205-a and outlet 210-a may be flanges designed based on the application of the fluid pumping system in which the fluid VDC 200-a is implemented.

FIG. 2B shows an angled perspective view of a fluid VDC 200-b in accordance with aspects of the present disclosure. The fluid VDC 200-b may include an inlet 205-b, an outlet 210-b, and a wide diameter chamber 215-b. The wide diameter chamber 215-b may have a length of at least three times the inner diameter of upstream pipe or an inner diameter of the inlet 205-b. Optionally, the fluid VDC 200-b may also include a drain port 220-b. The inlet 205-b and outlet 210-b may be flanges (e.g., RTJ flanges) designed to fit into the respective fluid pumping system in which the fluid VDC 200-b is implemented. The bolt pattern of the flanges may be based on the application or may be based on a standard (e.g., an American National Standards Institute (ANSI) standard).

FIG. 2C shows a cutaway perspective view of a fluid VDC 200-c in accordance with aspects of the present disclosure. The fluid VDC 200-c may include an inlet 205-c, an outlet 210-c, and a wide diameter chamber 215-c. The wide diameter chamber 215-c may have a length of at least three times the inner diameter of upstream pipe or an inner diameter of the inlet 205-c. Optionally, the fluid VDC 200-c may also include a drain port 220-c. The inlet 205-c and outlet 210-c may be flanges (e.g., RTJ flanges) designed to fit into the respective fluid pumping system the fluid VDC 200-c is implemented in. The bolt pattern of the flanges may be based on application or a standard.

As shown, the sidewall of the fluid VDC 200-c, specifically, of the wide diameter chamber 215-c, may be thicker than the downstream piping in the applicable fluid pumping system. Additionally, the fluid VDC 200-c may optionally include vanes 225 in the wide diameter chamber 215-c to assist in controlling the flowrate of the jet stream of fluid passing therethrough.

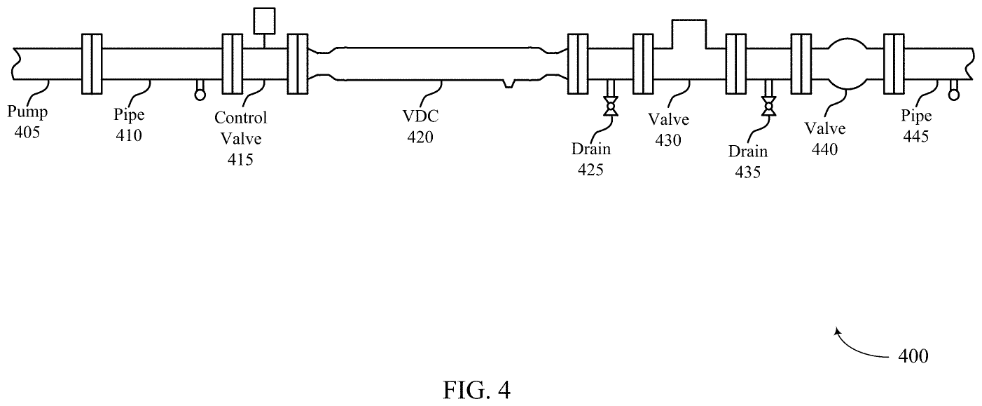

FIG. 3 illustrates an example of a two dimension cross-sectional view of a fluid VDC 300 in accordance with aspects of the present disclosure. In some examples, fluid VDC 300 may be an example of VDC 135 in saltwater disposal system 100 of FIG. 1 or fluid VDC 200, as described with reference to FIG. 2. The fluid VDC 300 may include an inlet 305, an outlet 310, and a wide diameter chamber 315. Optionally, the fluid VDC 300 may also include a drain port 320.

The inlet 305 and outlet 310 may be flanges (e.g., 4 inch class 1500 pipe flanges) designed to fit into the respective fluid pumping system in which the fluid VDC 300 is implemented. The bolt pattern of the flanges may be based on application or ANSI standards, for example. As shown, the sidewall of the fluid VDC 300, specifically, of the wide diameter chamber 315, may be thicker (e.g., a sidewall thickness of about 0.67 inches) than the downstream piping in the applicable fluid pumping system. Additionally, or alternatively, a length of the wide diameter chamber 315 along a longitudinal axis of the fluid VDC 300 (e.g., of length at three times the upstream pipe inner diameter or a length of about 5 to 50 inches) may be greater than a length of the inlet 305 and the outlet 310 along the longitudinal axis of the fluid VDC 300. A diameter of the wide diameter chamber 315 (e.g., a 6 inch, 7 inch, or 8 inch diameter) may be greater than a diameter of the inlet 305 and the outlet 310, where the diameter of the inlet 305 and the outlet 310 may be based on the piping in the applicable pumping system.

In some examples, the upstream pipe diameter may be 4 inches (e.g., the pipe the fluid flows through before inlet 305) and the VDC diameter may be 6 inches with a sidewall thickness of about 0.67 inches. A pump, such as pump 125 in FIG. 1, may be upstream of inlet 305, and the pump may have a 4 inch nominal diameter outlet such that the pump outlet may have a 4 inch outer diameter and 3.48 inch inner diameter. The pump outlet may have an effective cross sectional flow area of 9.51 square inches. The pressure at the pump outlet may be around 2000 psi, and the flowrate at the pump outlet may be around 292 gallons per minute (gpm). The fluid velocity at the pump outlet may be around 9.84 fps, and the system around the pump may be designed for a fluid velocity around 10 fps or 15 fps.

In this example, a control valve, such as valve 130 in FIG. 1, may be placed between the outlet of the pump and the inlet 305 of the VDC 300. The control valve may be closed, partially open, or completely open. At completely open (i.e., 100% open), the effective cross sectional flow area of the valve may be 1.58 square inches, which may be equivalent to a pipe diameter of 1.41 inches. The completely open valve may produce a downstream or outlet pressure of 1850 psi, flowrate of 292 gpm, and a fluid velocity of 59.96 fps. This fluid velocity may be greater than the design parameters of the system (e.g., 10 fps or 15 fps) and may cause damage downstream pipe or fittings. At partially open (e.g., 50% open or 20%-70% open), the effective cross sectional flow area of the valve may be 0.694 square inches, which may be equivalent to a pipe diameter of 0.94 inches. The partially open valve may produce a downstream or outlet pressure of 890 psi, flowrate of 292 gpm, and a fluid velocity of 134.91 fps. This fluid velocity may be greater than the design parameters of the system (e.g., 10 fps or 15 fps) and may cause greater damage downstream pipe or fittings than when the valve is completely open.

The VDC 300 may be designed to reduce this damage to downstream pipe or fittings from the valve outlet by allowing the fluid to slow to an acceptable velocity in the VDC 300 before reaching the downstream pipe or fittings. In this examples, the inlet 305 of VDC 300 may have a 4 inch nominal diameter. The wide diameter chamber 315 of VDC 300 may have a 6 inch outer diameter and a 4.897 inch inner diameter, which may have an effective cross sectional flow area of 18.83 square inches. The pressure in the wide diameter chamber 315 may be 1850 psi, the flowrate may be 292 gpm, and the fluid velocity may be 4.97 fps. Thus, the fluid velocity of outlet 310 may be about 5 fps to 15 fps. A downstream valve of the VDC 300, such as valve 140 in FIG. 1, may be a 4 inch valve with a flow area of 9.35 square inches. The pressure in the downstream valve may be 890 psi. The flowrate in the downstream valve may be 292 gpm, and the fluid velocity may be about 10 fps, which may be within the system design parameters and may reduce or eliminate damage to the valve. In some examples, an upper limit velocity in some valves may be about 15 fps, and a standard or target velocity in valves may be about 10 fps in some systems.

In some examples, the fluid VDC 300 may optionally include baffles 325 in the wide diameter chamber 315 to assist in dissipating the flowrate of the jet stream of fluid. For instance, fluid entering the fluid VDC 300 at the inlet 305 may enter at a first (e.g., high) velocity. The fluid may then impact or contact one or more of the baffles 325, which may cause the fluid direction to change and the velocity of the fluid to be reduced. In some cases, more or fewer baffles 325 may be present. In some cases, the fluid VDC 300 may optionally include wear plates 330 in the inlet 305 based on where the jet stream may contact the sidewall to provide further sidewall protection against erosion. For example, a wear plate 330 may be welded to a portion or the entire inner circumference of the inlet 305 in the area where fluid streams are likely to contact the inner wall of the inlet 305. In some cases, one or more wear plates may be welded to an inner sidewall of the wide diameter chamber 315 (e.g., positioned where high velocity fluid contact with the inner sidewall is most likely to occur, which may be based on fluid type or application). Additionally or alternatively, the fluid VDC 300 may optionally include dissipation plate 335 in at least a portion of the wide diameter chamber 315 to assist in dissipating the flowrate of the jet stream of fluid. Other dissipation plate designs or numbers of dissipation plates may be used.

The inlet 305 may be connected to the wide diameter chamber 315 via collar 345 and sloped portion 350. In some examples, the angle of the slope of sloped portion 350 may be driven by the availability of standard expansion and contraction pipe fittings. In other examples, the angle of the slope of sloped portion 350 may be designed based on the impact point of the jet stream or the application of the pumping system. The collar 345 and sloped portion 350 may be welded to the inlet 305. For example, welds 340 are shown at various locations on the fluid VDC 300. A similar configuration is also applicable to the outlet 310.

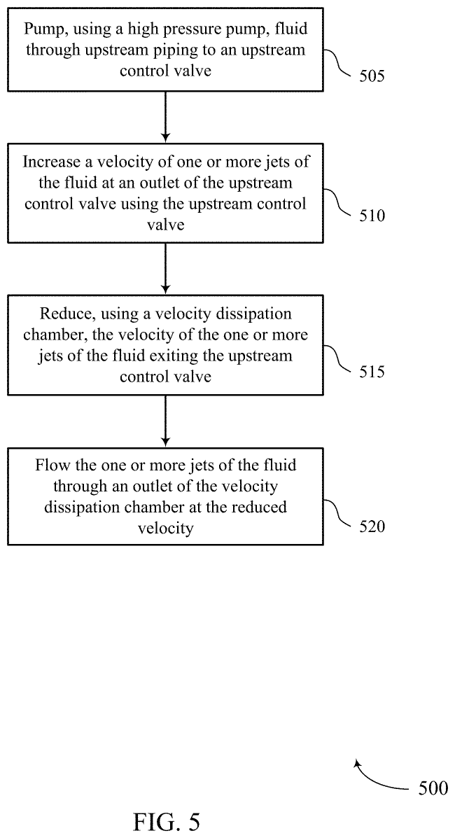

FIG. 4 illustrates an example of a high pressure piping system 400 that supports dissipating fluid velocity in accordance with aspects of the present disclosure. In some examples, high pressure piping system 400 may implement aspects of saltwater disposal system 100. For example, VDC 420 may be an example of VDC 135 in saltwater disposal system 100 or fluid VDC 200 or 300 as described with reference to FIGS. 2 and 3.

The high pressure piping system 400 may include a high pressure pump 405 and pipe 410. The high pressure piping system 400 may also include a valve 415. Fluid may exit the pump 405 at a first velocity. The fluid may flow from the pump 405 exit through pipe 410 at the first velocity. Then the fluid may exit the pipe 410 and travel through a reduced diameter of the valve 415, which may generate a high velocity jet stream of a second velocity at the outlet of valve 415. For example, valve 415 may be a choke valve with a very small diameter relative to the diameter of the pipe 410, and the second velocity of the fluid may be faster than the first velocity.

The high pressure piping system 400 may also include a VDC 420 to protect downstream drains 425 and 435, valves 430 and 440, and pipe 445 from the jet stream output from valve 615. For example, the VDC 420 may allow the jet stream of fluid exiting valve 415 to return to a slower velocity (e.g., the first velocity) than the second velocity of the jet stream, such that the velocity of the output of the VDC 420 may not damage the downstream equipment (e.g., drains 425 and 435, valves 430 and 440, and pipe 445). For instance, the fluid may impact a sidewall of the VDC 420 and enter the wide diameter chamber of the VDC 420. The increase in diameter from the valve to the input of the VDC 420 and the wide diameter chamber of the VDC 420 allows the fluid to slow from the second velocity to the first velocity or another velocity less than the second velocity that would not damage the downstream equipment. The VDC 420 may also include additional means, other than a wide diameter, to slow the fluid velocity. For example, baffles, plates, or vanes may be present in the VDC 420.

The fluid may exit the VDC 420 at a velocity less than the second velocity and enter the drain 425, valve 430, drain 435, valve 440, and pipe 445 at a velocity within the design parameters for the equipment. In some cases, an additional VDC may be used in the piping system 400 (not shown). For instance, an additional VDC may be installed between valve 430 and drain 435.

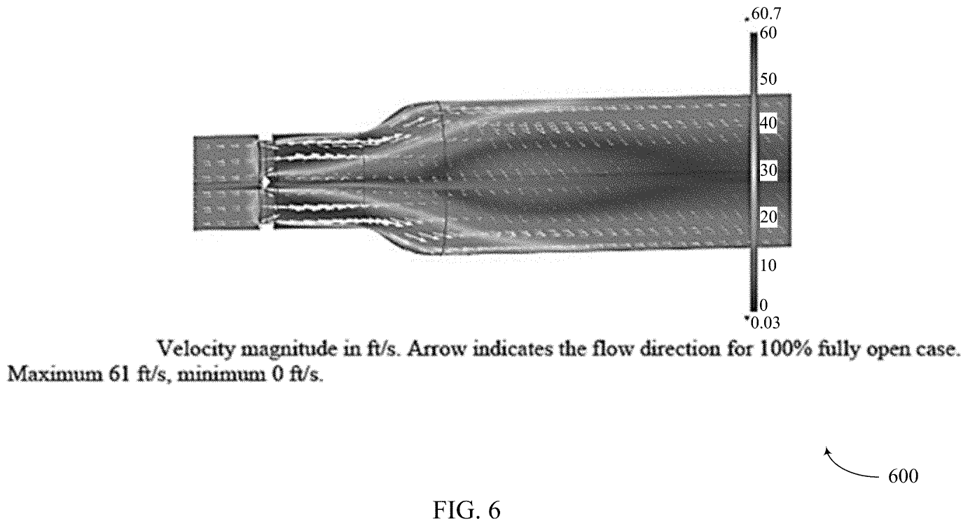

FIG. 5 shows a flowchart illustrating a method 500 that supports dissipating fluid velocity in accordance with aspects of the present disclosure. The operations of method 500 may be implemented by a piping system including a VDC or its components as described herein.

At 505, an upstream high pressure pump may pump fluid through upstream piping to an upstream control valve. The operations of 505 may be performed according to the methods described herein. In some examples, aspects of the operations of 505 may be performed by a pump as described with reference to FIG. 1.

At 510, the upstream control valve may increase a velocity of one or more jets of the fluid at an outlet of the upstream control valve. The operations of 510 may be performed according to the methods described herein. In some examples, aspects of the operations of 510 may be performed by an upstream valve as described with reference to FIG. 1.

At 515, the VDC may reduce the velocity of the one or more jets of the fluid exiting the upstream control valve. The operations of 515 may be performed according to the methods described herein. In some examples, aspects of the operations of 515 may be performed by a VDC as described with reference to FIGS. 1 through 4. In some examples, the VDC may reduce the velocity of the one or more jets using one or more baffles, one or more vanes, or one or more plates, or a combination thereof within the VDC.

At 520, the VDC may flow the one or more jets of the fluid through an outlet of the VDC at the reduced velocity. The operations of 520 may be performed according to the methods described herein. In some examples, aspects of the operations of 520 may be performed by a VDC as described with reference to FIGS. 1 through 4. In some examples, the VDC may flow the one or more jets of the fluid through the outlet to a downstream valve, where the velocity of the one or more jets is reduced based on one or more specifications of the downstream valve.

It should be noted that the methods described herein describe possible implementations, and that the operations and the steps may be rearranged or otherwise modified and that other implementations are possible. Further, aspects from two or more of the methods may be combined.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

### EXAMPLE

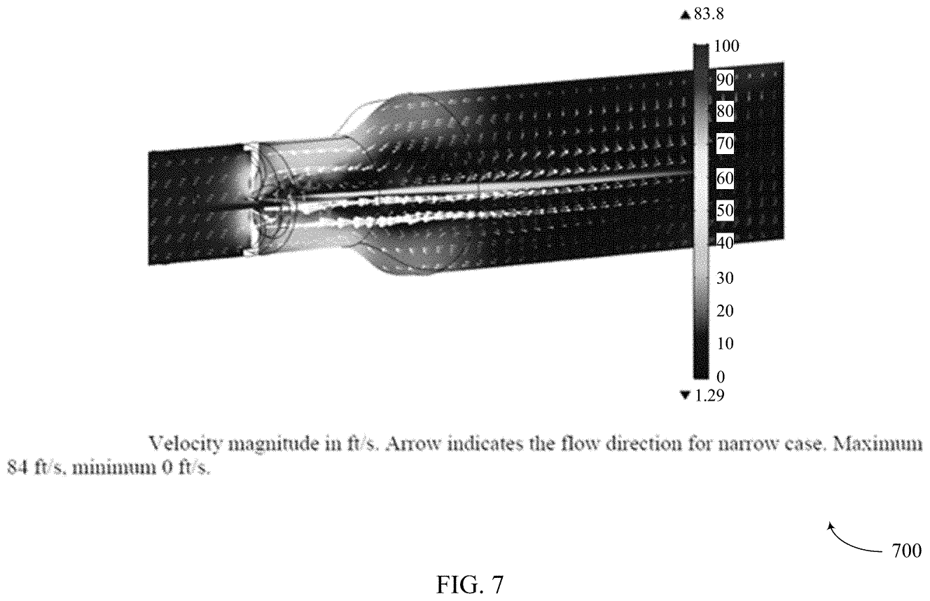

FIGS. 6 and 7 illustrate modeling results of a VDC in accordance with one or more aspects described herein.

Modeling of a VDC when the upstream valve is completely open shows that the flow first moves towards the center of the VDC as the fluid passes two orifice plates of the upstream control valve. Then, the fluid flows through the diverging section to the large downstream pipe and stabilizes without large scale circulation after about 3 to 4 times the pipe inner diameter. There is re-circulation of the fluid near the longitudinal center of the flow where flow backwards towards the upstream valve (e.g., choke valve). Additionally, the upstream valve generates strong turbulence kinetic energy, which dissipates after 3 to 4 times the inner diameter downstream to a level similar to that of the fluid upstream from the valve.

As for geometry, the dimensions of the choke valve piping system included in the modeling are a 3 inch to 3.48 inch inner diameter of the upstream pipe; a 4.90 inch diameter of the wide portion of the VDC; a 40 inch length of the VDC from the first weld to the last weld; and a 3 inch diameter of the inlet and outlet of the VDC. Also included are the sections of pipe before and after the choke valve with diffusing couplings. The choke valve fluid domain has 3 parts: two 3-inch-long straight halves, and a section of the fluid domain created by the orifice plates—the void created by the solid orifice plates to be more specific.

In the modeling example, the fluid is water. Inlet fluid flow is fully developed or at steady state. The flow is isothermal, and gravity is neglected. Inlet flow is 9.84 fps or 292 gpm.

The modeling is done in Finite element software-COMSOL Multiphysics with the standard k-epsilon turbulent model.

Results: Based on the inlet flow and pipe diameter, the Reynolds number is 381000, which is fully turbulent.

For a completely open upstream valve, flow passes through the upstream choke valve relatively easily. The maximum velocity increases to 60 fps from about 10 fps at the inlet of the valve. The flow slightly converges towards the center then quickly diverges as it flows through the diffusing coupling into a bigger inner diameter pipe of the VDC. Large scale eddies are formed in the downstream portion of the choke valve as well as in the diverging coupling. Flow within 3 inner diameter distance downstream of the choke valve is highly turbulent as shown in FIG. 6 (flow through VDC 600 is from bottom to top of FIG. 6). Flow returns to nearly fully developed and low turbulence level as the incoming upstream flow roughly after 5 to 7 inner diameter downstream of the choke. In terms of pressure drop caused by the choke, about 20 psi pressure is observed through choke valve under this flow rate. Note that the pressure is not absolute, nor is it the gauge pressure. The plotted pressure is relative to the pressure at the exit.

For a partially open upstream valve (i.e., 60 degree rotation of orifice plate from completely open), the maximum velocity occurs near the choke at 84 fps. The reserving flow and large-scale eddies are much stronger comparing to the fully open case. Turbulent intensity increases nearly 10 to 157 folds near the choke valve as shown in FIG. 7 (flow through VDC 700 is from bottom to top of FIG. 7). The flow downstream of the choke becomes rotational. It can be expected that for equipment that is sensitive to the upstream condition like vortex flow meters, the accuracy of the reading will be negatively affected. The flow is clearly rotational, nonetheless, the turbulent intensity had lessened significantly. The turbulence induced total stress should be mild near the outlet of the VDC assuming the VDC itself is rigidly supported with negligible vibration. The pressure drop increases dramatically to over 500 psi. This is a possible justification for the 2000 psi inlet pressure in the application.

What is claimed is:

1. An apparatus for a fluid pumping system, comprising:
an elongated pipe configured to allow fluid to flow therethrough, the elongated pipe having a first end and a second end;
an inlet portion at the first end of the elongated pipe;
an outlet portion at the second end of the elongated pipe; and
a dissipation chamber between the inlet portion and the outlet portion, the dissipation chamber configured to reduce a velocity of a stream of the fluid along a direction from the inlet portion to the outlet portion, wherein a cross-sectional area of the dissipation chamber perpendicular to the direction from the inlet portion to the outlet portion is greater than a cross-sectional area of the inlet portion perpendicular to the direction from the inlet portion to the outlet portion.

2. The apparatus of claim 1, wherein a length of the dissipation chamber along a longitudinal axis of the elongated pipe is greater than a length of the inlet portion and the outlet portion along the longitudinal axis of the elongated pipe.

3. The apparatus of claim 1, wherein a diameter of the dissipation chamber is greater than a diameter of the inlet portion and the outlet portion.

4. The method of claim 1, further comprising:
one or more baffles, one or more vanes, or one or more plates, or a combination thereof coupled to an inner sidewall of the dissipation chamber, the one or more baffles, the one or more vanes, or the one or more plates, or the combination thereof configured to reduce the velocity of the fluid along the direction from the inlet portion to the outlet portion.

5. The apparatus of claim 1, further comprising:
one or more wear plates coupled to the dissipation chamber and positioned with respect to a contact position of one or more streams of the fluid on an inner sidewall of the dissipation chamber.

6. The apparatus of claim 5, wherein the one or more wear plates cover a circumference of the inner sidewall of the dissipation chamber.

7. The apparatus of claim 1, further comprising:
one or more wear plates coupled to the inlet portion and positioned with respect to a contact position of one or more streams of the fluid on an inner sidewall of the inlet portion.

8. The apparatus of claim 1, further comprising:
a sloping section between the dissipation chamber and the inlet portion, wherein the sloping section is based at least in part on a first diameter of an inner wall of the inlet portion and a second diameter of an inner wall of the dissipation chamber.

9. The apparatus of claim 8, wherein a position and a slope of the sloping section is based at least in part on an angle of the stream of fluid.

10. The apparatus of claim 1, further comprising:
a drain port coupled with the velocity dissipation chamber configured to drain excess fluid from the velocity dissipation chamber.

11. The apparatus of claim 1, wherein the dissipation chamber is welded to the inlet portion and the outlet portion.

12. A fluid pumping system, comprising:
a control valve configured to control a stream of fluid from upstream piping to an outlet of the control valve;
a velocity dissipation chamber coupled with the control valve at an inlet end of the velocity dissipation chamber and configured to reduce a velocity of the stream of fluid along a direction between the outlet of the control valve and an outlet end of the velocity dissipation chamber; and
a downstream equipment coupled to the outlet end of the velocity dissipation chamber.

13. The fluid pumping system of claim 12, further comprising:
a high pressure pump configured to pump the fluid through the upstream piping to the control valve according to an operating envelope of the high pressure pump.

14. The fluid pumping system of claim 12, further comprising:
at least one baffle, vane, or plate within the velocity dissipation chamber configured to reduce the velocity of the stream of fluid along the direction between the outlet of the control valve and the outlet end of the velocity dissipation chamber.

15. The fluid pumping system of claim 12, further comprising:
one or more wear plates within the velocity dissipation chamber and positioned with respect to a point of contact of the stream on an inner wall of the velocity dissipation chamber.

16. The fluid pumping system of claim 12, wherein the velocity dissipation chamber is configured to reduce the velocity of stream of fluid according to one or more specifications of the downstream equipment.

17. The fluid pumping system of claim 12, wherein a diameter of the velocity dissipation chamber is greater than a diameter of the downstream equipment.

18. A method, comprising:
pumping, using a high pressure pump, fluid through upstream piping to an upstream control valve;
increasing a velocity of one or more jets of the fluid at an outlet of the upstream control valve using the upstream control valve;
reducing, using a velocity dissipation chamber, the velocity of the one or more jets of the fluid exiting the upstream control valve; and
flowing the one or more jets of the fluid through an outlet of the velocity dissipation chamber at the reduced velocity.

19. The method of claim 18, further comprising:
reducing the velocity of the one or more jets using one or more baffles, one or more vanes, or one or more plates, or a combination thereof within the velocity dissipation chamber.

20. The method of claim 18, further comprising:
flowing the one or more jets of the fluid through the outlet to a downstream valve, wherein the velocity of the one or more jets is reduced based at least in part on one or more specifications of the downstream valve.
